(19) United States
(12) Patent Application Publication
(10) Pub. No.: US 2025/0225259 A1
(43) Pub. Date: Jul. 10, 2025

(54) Methods for Executing a Workload (APP) in an Execution Environment and System

(71) Applicant: Siemens Aktiengesellschaft, München (DE)

(72) Inventor: Rainer Falk, Erding (DE)

(73) Assignee: Siemens Aktiengesellschaft, München (DE)

(21) Appl. No.: 18/852,634

(22) PCT Filed: Mar. 13, 2023
(86) PCT No.: PCT/EP2023/056307

§ 371 Date: Sep. 30, 2024

(30) Foreign Application Priority Data
Mar. 31, 2022 (EP) 22165806.5

(51) Int. Cl. G06F 21/60; G06F 21/57

(52) U.S. Cl. CPC G06F 21/604; G06F 21/577; G06F 2221/2141

(57) ABSTRACT

Various embodiments of the teachings herein include a method for executing workloads in an execution environment. An example includes: determining approval of the workload for execution using a list of admissible workloads; determining information identifying an IT security risk of the execution environment; and amending the admissibility list of admissible workloads depending on the determined risk information.

### CROSS-REFERENCE TO RELATED APPLICATIONS

This application is a U.S. National Stage Application of International Application No. PCT/EP2023/056307 filed Mar. 13, 2023, which designates the United States of America, and claims priority to EP application Ser. No. 22/165,806.5 filed Mar. 31, 2022, the contents of which are hereby incorporated by reference in their entirety.

### TECHNICAL FIELD

The present disclosure relates to execution environments on computing platforms. Various embodiments of the teachings herein include systems and/or methods for executing a workload in an execution environment.

### BACKGROUND

In execution environments, for instance on computing platforms, such as industrial PCs or edge cloud computer servers, different and in part critical software components are executed. In particular, critical functionalities, for instance in the form of apps and/or containers or native software components, can be realized on open compute platforms. Generally, such apps, containers and other software components may also be referred to as “workload”.

However, it is not possible to prevent a critical workload from being executed on a compute platform which does not ensure the required trustworthiness.

### SUMMARY

Teachings of the present disclosure provide improved methods and/or systems for executing a workload in an execution environment. In particular, the teachings make it possible to execute a workload even on an execution environment that cannot be categorized as trustworthy from the outset. As an example, some embodiments include a method for executing a workload (APP) in an execution environment (APPRTE, IOM) in which the workload is approved for execution by means of an admissibility list (APPWL) of admissible workloads, wherein in the method risk information, identifying an IT security risk of the execution environment, is determined (DETTRU) and the admissibility list of admissible workloads is changed (DETWL) depending on the determined risk information.

In some embodiments, the workload can comprise one or more elements of the list presented hereinafter: a virtual machine, an operating system container, in particular a Linux (LXC) or a Docker container or a container-based app, a native operating system application, a service, in particular a Unix Demon or a Windows service, an operating system module, e.g. an operating system module that is dynamically loadable by the Linux kernel.

In some embodiments, during ongoing operation of the execution environment (APPRTE, IOM), the risk information of the execution environment (APPRTE, IOM) is determined and the admissibility list is changed, in particular selected or formed, depending on the determined risk information.

In some embodiments, the execution environment (APPRTE, IOM) comprises a runtime environment (APPRTE), in particular for workloads in the form of software components, e.g. in the form of containers and/or apps (APP).

In some embodiments, the execution environment (APPRTE, IOM) comprises an operating system (OS) and/or at least one input-output module (IOM) and/or at least one signal connection and/or at least one switch and/or at least one router.

In some embodiments, the risk information is determined by means of the execution environment (APP, IOM) or by means of a device (CS) in which the execution environment is situated, or by means of software that runs in the execution environment, or wherein the risk information is determined by means of a component communicatively connected to the execution environment.

In some embodiments, the admissibility list (APPWL) is a positive list.

In some embodiments, the admissibility list (APPWL) has at least two or more entries of admissible workloads.

In some embodiments, the admissibility list (APPWL) is cryptographically protected.

In some embodiments, the risk information is determined (DETTRU) repeatedly, in particular at constant time intervals or in a manner controlled by events, and the admissibility list of admissible workloads is changed (DETWL) in each case depending on the determined risk information.

As another example, some embodiments include a system comprising an execution environment (APPRTE, IOM) for executing a workload (APP) in which an admissibility (APPWL) list of admissible workloads (APP) is present and wherein the system is configured for executing a workload in accordance with the admissibility list (APPWL), having a risk determining module (HIC) for determining risk information, identifying an IT security risk of the execution environment (APPRTE, IOM), and also an admissibility list adapting module (AWA) configured to change the admissibility list (APPWL) of admissible workloads (APP) depending on the risk information.

In some embodiments, the system forms an integral or unipartite or integrally or unipartitely handleable device (CS).

In some embodiments, the system is configured for executing one or more of the methods described herein.

### BRIEF DESCRIPTION OF THE DRAWINGS

The teachings of the present disclosure are explained in greater detail below on the basis of an exemplary embodiment illustrated in the drawing, in which:

FIG. 1 shows one example of a system incorporating teachings of the present disclosure for executing a workload in an execution environment for executing a method for executing a workload in this execution environment; and

FIG. 2 shows the sequence of an example method incorporating teachings of the present disclosure schematically in a flowchart.

### DETAILED DESCRIPTION

Some embodiments of the teachings herein include a method for executing a workload in an execution environment. In an example method, the workload is approved for execution by means of an admissibility list of admissible workloads, wherein in the method risk information, identifying an IT security risk of the execution environment, is determined and the admissibility list of admissible workloads is changed depending on the determined risk information. In some embodiments, the method is computer-implemented method.

The admissibility list of admissible workloads means an admissibility list of an admissible workload, i.e. an admissibility list with an admissible workload recorded on this list. An IT security risk of the execution environment should be understood to mean in particular an IT security risk resulting from the execution environment for the execution of a workload and/or expediently identifies a host trust status.

In some embodiments, the IT security risk of the execution environment is determined by means of a software-based integrity checking module. In other words, the integrity of the execution environment may be checked in a software-based manner by the integrity checking module and the risk information is determined in a software-based manner with the aid of the checked integrity. A high integrity means a low IT security risk, and vice versa.

Therefore, it is not necessary to have trust from the outset in the execution environment being trustworthy, rather a workload is executed in the execution environment only if the trustworthiness thereof has been determined and checked, if an admissibility list for an admissible workload has then been selected depending on the checked trustworthiness and the workload has subsequently been recorded in this admissibility list. Therefore, a “zero trust” paradigm of network security is applied to the execution of a workload in an execution environment. Consequently, it is possible to use an admissibility list adapted to the risk of the execution environment and consequently adapted to the trustworthiness of the execution environment.

The workload involves software components. The execution environment may be a computer platform, in particular an open computer platform. Precisely in the case of execution environments which are formed by means of open compute platforms and consequently include higher risks for manipulations or attacks, a continuous adaptation of the admissibility list to the risk information of the compute platform is possible by means of the methods described herein. In some embodiments, the workload is executed with the changed admissibility list. In particular, the workload includes a control functionality of a manufacturing or maintenance process, such that the control functionality can be executed and the manufacturing or maintenance process can be controlled and executed.

In some embodiments, the workload comprises one or more of the elements of the list presented hereinafter: a virtual machine, an operating system container, in particular a Linux LXC or a Docker container or a container-based app, a native operating system application, a service, in particular a Unix Demon or a Windows service, an operating system module, e.g. an operating system module that is dynamically loadable by the Linux kernel.

The aforementioned software components can firstly themselves be stored on the execution environment or be loaded from a connected network memory into the execution environment for execution. A software component is started, i.e. executed and/or loaded into the main memory, only if it is defined as admissible by the admissibility list.

The risk information simultaneously denotes a host trust status of the execution environment. For the higher the risk indicated by the risk information for the execution, the less trustworthy the execution environment.

In some embodiments, during ongoing operation of the execution environment, the respective risk information of the execution environment is determined and the admissibility list is changed, in particular selected or formed, depending thereon. In the case where an admissibility list is selected, a plurality of admissibility lists are present, one admissibility list of which is selected depending on the risk information of the execution environment. In the case where the admissibility list is formed, an admissibility list dependent on the determined risk information of the execution environment is determined in such a way that only such a workload which is compatible with the determined risk information of the execution environment becomes established in the admissibility list.

In this regard, a database can be kept available which notes for each workload, i.e. for each software component, the risk information of the execution environment for which the workload can become established in the admissibility list, and the risk information for which it cannot become established therein. Expediently, the risk information comprises a numerical value and the database notes for each workload the numerical value starting from which or up to which the workload can be included in the admissibility list. In this way, an admissibility list can easily be generated in an automated manner.

In some embodiments, that already started workload or those software components is or are stopped or ended if the execution thereof is no longer admissible in accordance with the updated admissibility list. An already started software component can thus be stopped, ended or migrated to a different host depending on whether the admissibility list is maintained or has been changed.

In some embodiments, the admissibility list contains authorization information, i.e. information about what runtime authorizations are granted to a workload, in particular to a respective software component, for instance Linux capabilities, mandatory access control policies or access authorization to specific hardware components of the compute server such as in particular to a trust anchor for storing and providing cryptographic keys and functions or to a graphics accelerator or to an AI accelerator.

In some embodiments, the execution environment comprises a runtime environment, in particular for workloads in the form of software components, e.g. in the form of containers and/or apps.

In some embodiments, the execution environment comprises an operating system and/or at least one input-output module and/or a signal connection and/or a switch and/or a router.

The risk information may be determined by means of the execution environment or by means of a device in which the execution environment is situated, or by means of software that runs in the execution environment.

The risk information of the execution environment can be determined on the execution environment itself, in particular by means of a specific software component which is executed in particular in a “trusted execution environment”, referred to for short as “TEE”, of the execution environment, suitably an Intel SGX or an Arm TrustZone, or by means of a hardware expansion module, for instance a plug-in card such as in particular a PCIe card, or by means of an integrated hardware component of the execution environment or by means of a backend/edge cloud service. In some embodiments, the risk information of the execution environment can be determined by means of a device or platform communicatively connected to the execution environment.

In some embodiments, the admissibility list is a positive list, i.e. the software components approved for execution are recorded in the admissibility list.

Suitably, the admissibility list may be cryptographically protected. In this development, the admissibility list cannot straightforwardly be changed unintentionally or owing to an attacker's attempt at manipulation. Consequently, in this development, the methods may be particularly secure. The admissibility list can be cryptographically protected in particular by means of a digital signature of the admissibility list, for instance on the part of an admissibility list adapting module optionally present, as is described below. In this way, attackers wanting to manipulate the admissibility list have to manipulate not just the admissibility list but also the digital signature or the admissibility list adapting module optionally present.

In some embodiments, the admissibility list can be kept available in a manner encrypted by means of a cryptographic key, such that the admissibility list can be implemented only in the event of simultaneous manipulation or compromising of the cryptographic key or of a private key associated with the cryptographic key. The admissibility list can be protected in particular by means of a cryptographic check value, for instance a cryptographic checksum, or by means of an authenticating encryption. The admissibility list is expediently present in the form of a so-called “verifiable credential” or a “verifiable presentation. In some embodiments, the admissibility list can be stored in a distributed database, in particular in a distributed ledger or a blockchain, or a check value of the admissibility list can be stored in the distributed ledger or in the blockchain.

In some embodiments, the admissibility list is protected by means of a cryptographically protected communication channel, preferably by means of TLS and/or HTTPS.

In some embodiments, a first version of the admissibility list can be determined during device start-up, in particular during booting, of the execution environment. For this purpose, the admissibility list can be loaded in particular from a nonvolatile memory or from a server.

During ongoing operation of the execution environment, the admissibility list may be repeatedly updated, that is to say that the method is executed repeatedly. This can be done in particular in a time-controlled manner, at constant time intervals, or in conjunction with specific events, in particular upon a change in the configuration or a change in installed software, upon installation of a patch or upon logon or logoff of a user, in particular an administrator or privileged user, for instance a user having root privileges. In the absence of an update or the absence of a validity confirmation of the admissibility list over a defined period of time, a locally stored substitute admissibility list can optionally and advantageously be provided.

In some embodiments, in addition to the determined risk information of the execution environment, risk information can be determined by further components communicatively connected to the execution environment and can be taken into account in the formation of the admissibility list of the execution environment. The communicatively connected components can be in particular input/output modules via which a control application executable in the execution environment can access physical sensors and/or actuators directly or by means of a data network, expediently by means of Ethernet TSN, by means of 5G mobile radio, HART, Profinet, OPC UA.

An example system comprising an execution environment is configured for executing a workload in the execution environment. In the system, an admissibility list of admissible workloads is present and the system is configured for executing a workload in accordance with the admissibility list. In addition, the system has a risk determining module for determining risk information, identifying an IT security risk of the execution environment, and also an admissibility list adapting module configured to change the admissibility list of admissible workloads depending on the risk information.

The system expediently forms an integral or unipartite or integrally or unipartitely handleable device.

In some embodiments, the system is configured for, in particular repeatedly or continuously, executing a method according to the invention as described above. In this case, the system has the advantages corresponding to those already described and explained with respect to the methods described herein.

In some embodiments, the methods as described above are executed by a system as described in the foregoing.

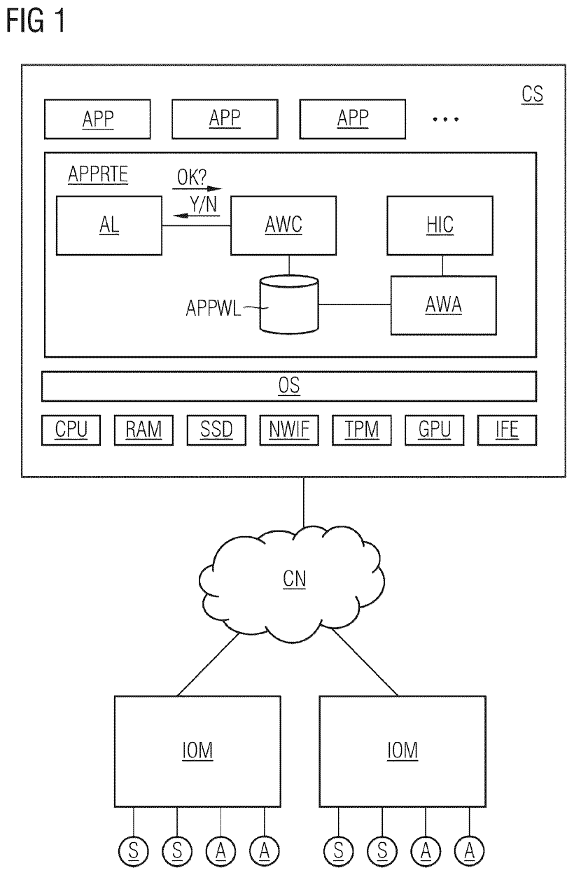

In the automation system incorporating teachings of the present disclosure as shown in FIG. 1, an open computing platform CS has a runtime environment APPRTE, in which are executed a plurality of apps APP, which are Linux containers or virtual machines in the exemplary embodiment illustrated. The open computing platform CS additionally has an operating system OS and also some hardware components, which in the exemplary embodiment illustrated are a processor CPU, a main memory RAM, a solid-state drive SSD, a network interface NWIF, a hardware trust anchor TPM, a graphics accelerator GPU and an AI accelerator IFE.

One of the apps APP realizes for example a control unit functionality in the form of a virtual programmable logic component which accesses sensors S and actuators A by means of a control network CN and by means of input-output modules IOM. An app APP can be executed, i.e. started and loaded into the main memory RAM, only if it is admissible in accordance with a software component whitelist APPWL stored in the execution environment. In this case, the execution environment is realized by means of the runtime environment APPRTE. During ongoing operation, the app whitelist APPWL is repeatedly updated depending on risk information indicating an IT security risk of the runtime environment APPRTE. In the case of a low IT security risk, the risk information simultaneously indicates a high trustworthiness of the runtime environment APPRTE. Conversely, a high IT security risk indicates a low trustworthiness of the runtime environment APPRTE. In this respect, the risk information is equivalent to trust status information of the runtime environment APPRTE.

In addition to the risk information of the runtime environment APPRTE, in the automation system, it is possible to take account of risk information of the IO modules IOM and risk information of the sensors S, and also risk information of the actuators A and/or of the control network CN or of individual network components of the control network CN, for example of a switch and/or of a router and/or of cabling and/or of a WLAN access point and/or of a 5G mobile radio base station. This is because the further aforementioned elements also belong, in addition to the runtime environment APPRTE, to the execution environment of the open compute platform CS.

In the automation systems described herein, the aforementioned items of risk information are continuously determined and the software component whitelist APPWL is adapted in each case depending on the items of risk information. This takes place in the computing platform CS as follows: by means of a software-based integrity checking module HIC, the integrity of the compute platform CS is checked and the risk information is determined. A high integrity means a low IT security risk, and vice versa.

Depending on the determined risk information, in the computing platform CS, the software component whitelist APPWL is adapted by means of a whitelist adapting module AWA. An application launcher AL intending to start an app APP as mentioned above firstly checks, by means of a query OK? to a checking module AWC, whether the app APP is recorded in the software component whitelist APPWL as admissible for execution in the runtime environment APPRTE. The checking module AWC communicates the response Y/N back to the application launcher AL. If the app APP is contained in the software component whitelist APPWL, then the app APP is started by the application launcher AL.

Other critical apps APP which are executed only depending on the trust status of the host, i.e. are approved by the software component whitelist correspondingly adapted in each case, are e.g. an encryption app for encrypting or decrypting data or a network transmission, an app for onboarding or provisioning of other devices, or an app for training an AI model.

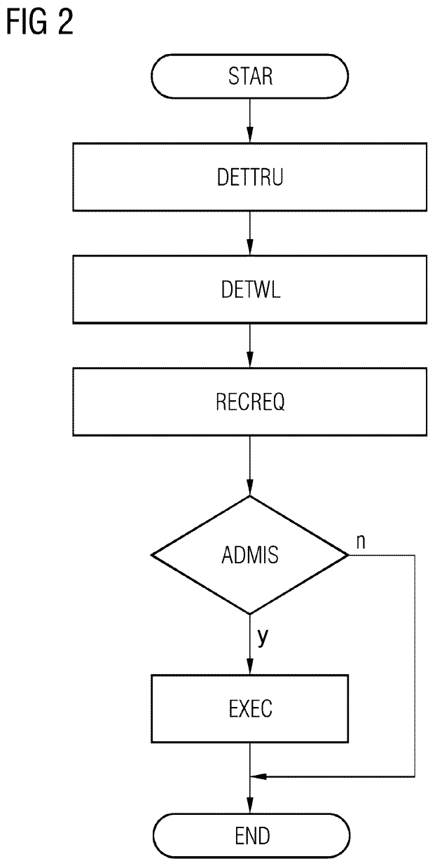

In FIG. 2, the method is illustrated compactly again in a flowchart:

The method is initiated in an initiation step STAR. This initiation step STAR can take place for example regularly at constant time intervals or in a manner adapted to requirements, for instance upon changes in the execution environment or upon changes in the device in which the execution environment is implemented.

A determining step DETTRU involves determining risk information of the execution environment, which quantifies the IT security risk of the execution environment, by means of the integrity checking module HIC in the exemplary embodiment illustrated.

Depending on this risk information, the software component whitelist APPWL—associated with the risk information—of an admissible workload, of admissible applications APP which are permitted to be executed in the runtime environment APPRTE in the exemplary embodiment illustrated, is selected. For this purpose, in the exemplary embodiment illustrated, the risk information forms a risk measure indicating a large risk when the risk measure has a high numerical value, and a low risk when it has a small numerical value. The value range of the values which the risk measure can assume is divided into value intervals. Each value interval is assigned a specific software component whitelist APPWL, which can thus easily be determined on the basis of the risk measure. All software component whitelists APPWL of the different value intervals differ from one another. The higher the risk measures of a value interval are, the fewer entries the software component whitelist has. As the risk measure increases, entries still existing in each case are excluded from software whitelists APPWL of the respective preceding value component interval in the ascending direction. By means of this assignment specification, the assigned software component whitelist APPWL is then determined on the basis of the risk measure in a determining step DETWL.

In the exemplary embodiment illustrated, all software component whitelists APPWL are cryptographically protected and additionally signed by means of a digital signature on the part of a user of the compute platform CS.

By means of the software component whitelist APPWL determined in this way, it is then possible to react adequately to incoming requests RECREO for execution of a workload: upon each request RECREQ the workload respectively requested for execution is compared with the software component whitelist APPWL determined by means of the determining step DETWL, and a checking step ADMIS checks whether the requested workload is recorded with an entry as admissible in the software component whitelist APPWL. If this is confirmed y, then the requested workload is executed in an execution step EXEC by means of the application launcher AL. If the requested workload is not recorded with an entry as admissible in the software component whitelist APPWL, then the checking step ADMIS ends with a denial n of the execution and the method ends with an ending step END without the execution step EXEC being undertaken.

In the exemplary embodiment illustrated, the application launcher AL additionally checks whether the software component whitelist APPWL has the required cryptographic protection and whether the digital signature of the software component whitelist is valid.

In further embodiments, not specifically illustrated, a software component whitelist APPWL in the manner of a positive list of admissible workloads need not be provided, rather a blacklist of exceptions to an admissible workload can alternatively be provided, which is adapted depending on the risk information.

What is claimed is:

1. A method for executing workloads in an execution environment, the method comprising:
determining approval of the workload for execution using a list of admissible workloads;
determining information identifying an IT security risk of the execution environment; and
the admissibility list of admissible workloads depending on the determined risk information.

2. The method as claimed in claim 1, wherein the workload comprises: one or more elements selected from the list consisting of: a virtual machine, an operating system container, a native operating system application, a service, and an operating system module.

3. The method as claimed in claim 1, further comprising determining the risk information of the execution environment during ongoing operation of the execution environment.

4. The method as claimed in claim 1, wherein the execution environment comprises a runtime environment.

5. The method as claimed in claim 1, wherein the execution environment comprises an operating system, an input-output module, a signal connection, a switch, and/or a router.

6. The method as claimed in claim 1, wherein:
the risk information is determined using the execution environment or a device in which the execution environment is situated, or software that runs in the execution environment; or
wherein the risk information is determined by means of a component communicatively connected to the execution environment.

7. The method as claimed in claim 1, wherein the admissibility list comprises a positive list.

8. The method as claimed in claim 1, wherein the admissibility list has two or more entries of admissible workloads.

9. The method as claimed in claim 1, wherein the admissibility list is cryptographically protected.

10. The method as claimed in claim 1, wherein the risk information is determined repeatedly and the admissibility list of admissible workloads is changed in each case depending on the determined risk information.

11. A system comprising:
an execution environment to execute a workload in which an admissibility list of admissible workloads is present; and
wherein the system is configured for executing a workload in accordance with the admissibility list,
a risk determining module to determine risk information identifying an IT security risk of the execution environment; and
an admissibility list adapting module to change the admissibility list depending on the risk information.

12. The system as claimed in claim 11, wherein the system comprises an integral or unipartite or integrally or unipartitely handleable device.

13. (canceled)
